(19) United States
(12) Patent Application Publication
(10) Pub. No.: US 2013/0327050 A1
(43) Pub. Date: Dec. 12, 2013

(54) CONTROLLING FLAME STABILITY OF A GAS TURBINE GENERATOR

(71) Applicants: Ilya Aleksandrovich Slobodyanskiy, Greenville, SC (US); Michael John Hughes, Greer, SC (US); Vijaykant Sadasivuni, Bear, DE (US)

(72) Inventors: Ilya Aleksandrovich Slobodyanskiy, Greenville, SC (US); Michael John Hughes, Greer, SC (US); Vijaykant Sadasivuni, Bear, DE (US)

(73) Assignee: GENERAL ELECTRIC COMPANY, Schenectady, NY (US)

(21) Appl. No.: 13/491,087

(22) Filed: Jun. 7, 2012

(51) Int. Cl. F02C 9/00; F02C 3/20; F02C 3/04

(52) U.S. Cl. 60/772; 60/39.23; 60/39.52

(57) ABSTRACT

A method and apparatus for controlling a flame stability at a gas turbine generator is disclosed. The method includes forming combustible mixtures at a plurality of fuel nozzles of a combustor of the gas turbine generator; altering an oxygen concentration of at least one of the combustible mixtures at a selected fuel nozzle of the plurality of fuel nozzles; and burning the combustible mixtures at the plurality of fuel nozzles to control the flame stability at the gas turbine generator.

### BACKGROUND OF THE INVENTION

The subject matter disclosed herein relates to a method and apparatus for controlling flame stability in a gas turbine generator. Gas turbine generators operate by burning a combustible mixture of compressed air and fuel to produce a working gas that causes a rotation of a rotary drive shaft. Exhaust from gas turbines is composed of varying amounts of NOx, CO, CO₂, H₂O, and O₂. An important issue in operating gas turbine generators is reducing or controlling the levels of these emissions. One way of controlling these levels includes burning a fuel/air mixture that lies within a selected region of a fuel equivalence ratio. Depending on the purpose for which the gas turbine is used or various emissions restrictions, this selected region can be small. Emission levels can also be reduced by lowering an oxygen concentration of the combustible mixture. However, lowering the oxygen concentration too much leaves the flame vulnerable to flame instabilities or to being altogether extinguished. The present disclosure therefore provides a method of increasing a stability of a flame burning in the gas turbine generator while maintaining selected emission levels.

### BRIEF DESCRIPTION OF THE INVENTION

According to one aspect of the present disclosure a method is provided for controlling a flame stability at a gas turbine generator, including: forming combustible mixtures at a plurality of fuel nozzles of a combustor of the gas turbine generator; altering an oxygen concentration of at least one of the combustible mixtures at a selected fuel nozzle of the plurality of fuel nozzles; and burning the combustible mixtures at the plurality of fuel nozzles to control the flame stability at the gas turbine generator.

According to another aspect of the present disclosure, an apparatus is provided for controlling a flame stability of a gas turbine generator, including: a plurality of fuel nozzles of a combustion chamber at the gas turbine generator configured to form a plurality of combustible mixtures; and a flow element configured to alter an oxygen concentration of a combustible mixture at a selected fuel nozzle of the plurality of fuel nozzles to control the flame stability of a flame resulting from burning the combustible mixtures.

According to yet another aspect of the present disclosure, a gas turbine generator is provided that includes: a combustor having a plurality of fuel nozzles configured to form combustible mixtures for burning in the combustor; and a flow element configured to alter oxygen concentrations at the combustible mixtures, wherein burning the combustible mixtures having the altered oxygen concentrations produces substantially the same emission levels as the burning combustible mixtures having substantially the same oxygen concentration.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary gas turbine generator in one embodiment of the present disclosure;

FIG. 2 illustrates a combustion chamber of the exemplary gas turbine generator illustrating active supply of a control gas to the combustion chamber in an exemplary embodiment of the present disclosure;

FIGS. 3 and 4 show a passive flow elements for controlling supply of control gas to a fuel nozzle;

FIG. 5 shows a flame stability diagram showing various operating regions of a flame according to an exemplary embodiment of the present disclosure; and

FIG. 6 shows an outline of an exemplary process of selective injection of gases to control a stability of a combustion flame.

The detailed description explains embodiments of the invention, together with advantages and features, by way of example with reference to the drawings.

### DETAILED DESCRIPTION OF THE INVENTION

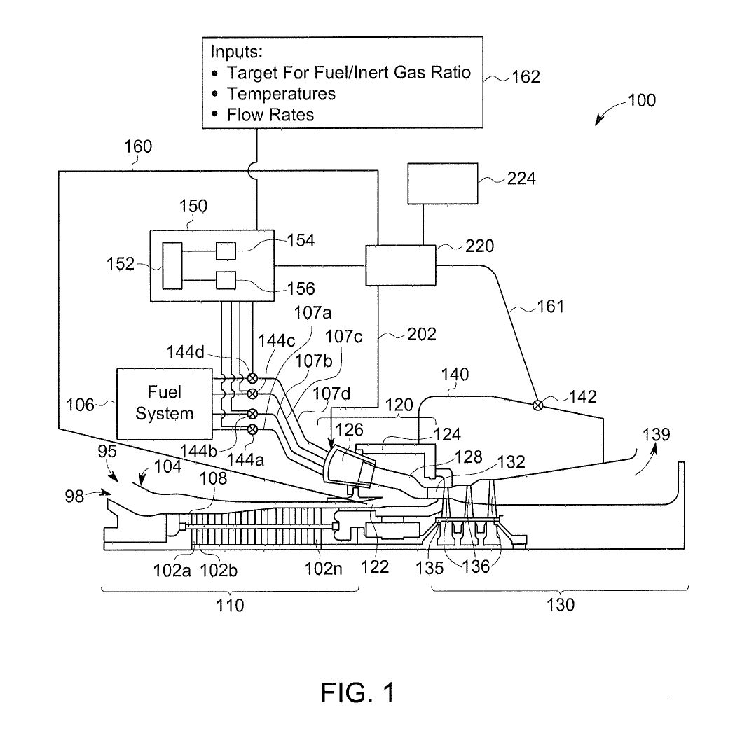

FIG. 1 shows an exemplary gas turbine generator 100 in one embodiment of the present disclosure. Generally, the gas turbine generator 100 includes a compressor section 110, a combustion section 120 and a turbine section 130. The compressor section 110 includes a plurality of compressor stages 102a . . . 102n for compressing air. An exemplary compressor stage includes stationary vanes supported by an outer housing 104 of the compressor section 110 and rotating blades which are mounted on a common compressor shaft 108. Ambient air 95 is introduced through inlet 98 and is successively compressed at each compressor stage by rotation of the blades. After being compressed at the final compression stage (102n), the compressed air is discharged from the compression section 110 through an annular diffuser 122 to a compressed air chamber 124 which surrounds a combustion chamber 126 and transition member 128 of the combustion section 120. The compressed air is typically mixed with recirculated exhaust gas (EGR) in the compressed air chamber 124, in general, to reduce NOx emissions. The mixture of compressed air and EGR is supplied to the combustion chamber 126 where it is mixed with fuel and a control gas to form a combustible mixture of fuel and gases having a selected oxygen concentration. This combustible mixture is then burned in the combustion chamber 126 to create a working gas. The working gas is directed through the transition member 128 and a turbine nozzle 132 to enter the turbine section 130. The turbine section 130 is made of a serial arrangement of stages, each stage having rotating blades known as buckets 136. The buckets are supported by a rotary shaft 135. The working gas exiting the transition member 128 expands through the serial stages to cause rotation of the buckets 136. The rotation of the buckets in turn imparts rotation to the rotary shaft 135. In one aspect, the rotary shaft 135 is coupled to the compressor shaft 108 so that rotation of the rotary shaft 135 drives the rotation of the blades of the compressor section 110. In power plant applications, the rotary system 135 is generally coupled to a rotor of an electrical generator (not shown) to drive the generator to create electricity. The working gas ultimately is released at the exhaust 139 of the turbine section 130 and can be directed through an exhaust stack to the ambient atmosphere, to a cooling unit or to a heat exchanger. Conduit 140 recirculates a portion of the exhaust gas from the turbine exhaust 139 to the combustion chamber 126 for mixing with the compressed air. EGR valve 142 in the conduit 140 can be adjusted to control the amount of exhaust gas that is recirculated.

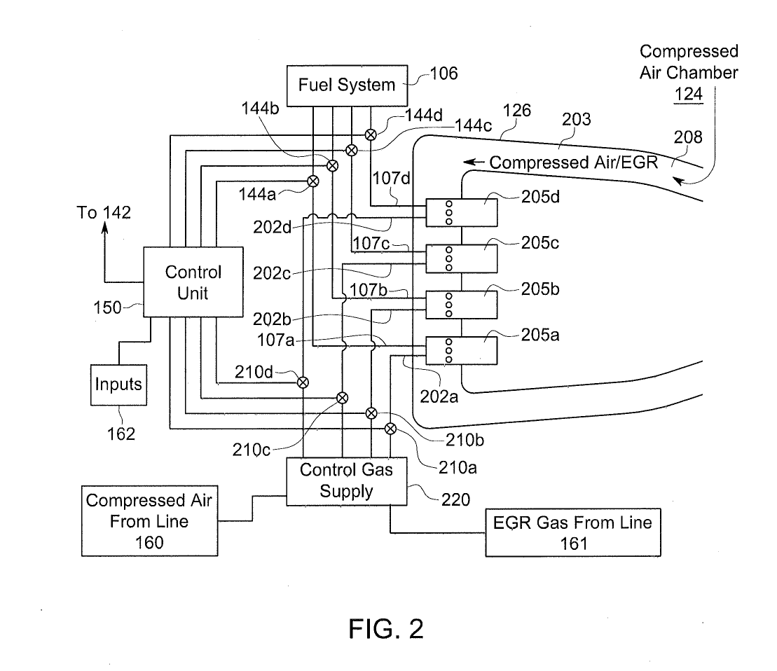

The generator system 100 further includes a fuel system 106 for providing fuel to the combustion section 120 for burning in the combustion chamber 126. One or more fuel lines 107a-107d provide fuel from the fuel system 106 to various fuel nozzles of the combustion chamber 126 shown in FIG. 2 Gas control valves 144a-144d are coupled to fuel lines 107a-107d, respectively, and can be individually adjusted to control the flow of the fuel in the fuel lines 107a-107d. A control gas supply 220 provides control gas to the fuel nozzles and combustion chamber via control gas line 202. The control gas can be an inert gas, oxygen, an ambient air supplied via conduit 160 from annular diffuser 122 or an EGR via conduit 161. An inert gas supply can be used to supply the inert gas and/or oxygen to the control gas supply 220.

In an exemplary embodiment, a control unit 150 controls a fuel mixture at a fuel nozzle of the combustion chamber 126. The control unit 150 can be coupled to control valve 142 and gas control valves 144a-144d to control a composition of the combustible mixture at the combustion chamber 126. The control gas can be further coupled to control gas supply 220 to control the composition of the control gas. In various embodiments, the control unit 150 can control a valve configuration of EGR valve 142 and gas control valves 144a-144d as well as gas supply valves controlling the supply of the control gas to the fuel nozzles. The various valves can be controlled in order to control at least one of recirculation of the exhaust gas to the combustion chamber, the fuel flow rate and the flow of control gas to the fuel nozzles to control an oxygen concentration of the combustible mixture. The control unit 150 includes a memory 154, a set of programs 156 storing instructions therein for operating the gas turbine generator 100 according to the methods of the present disclosure described herein, and a processor 152 having access to the set of programs 156 and to the contents of the memory 154. The processor 152 is configured to run the various programs 156 for controlling flame stability according to the methods disclosed herein. In addition, various inputs 162 can be provided to the control unit 150 including, for example, a target fuel/inert gas ratio, various temperature, fuel flow rates, EGR flow rates, etc., that are used in the operation of the gas turbine according to the various methods disclosed herein.

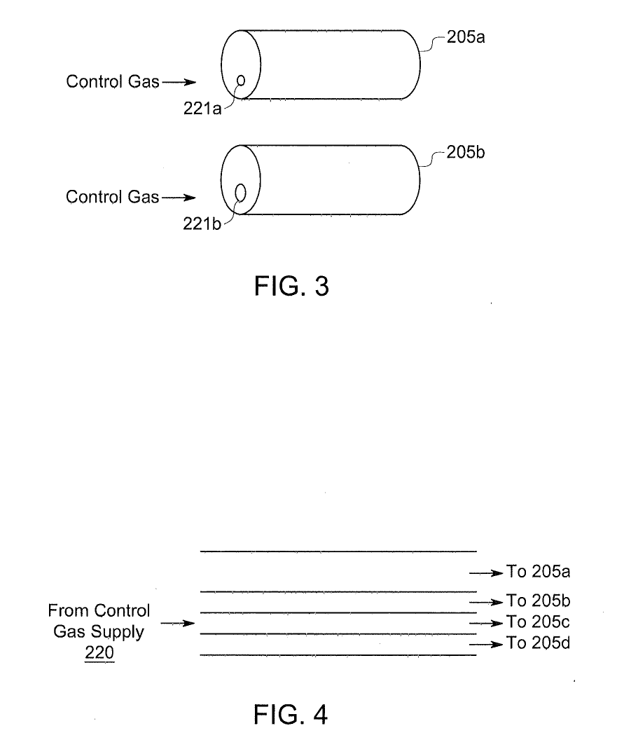

FIG. 2 illustrates an exemplary combustion chamber 126 of the present disclosure illustrating active supply of a control gas to the combustion chamber in an exemplary embodiment. The combustion chamber 126 includes a plurality of fuel nozzles 205a-205d that are used to mix the fuel and gases to form a combustible mixture for combustion. Fuel lines 107a-107d are shown supplying fuel to their respective nozzles 205a-205d. Control gas lines 202a-202d are also shown supplying control gas to their respective nozzles 205a-205d. The control gas generally includes an inert gas and can include for example nitrogen and/or steam or EGR. Control gas lines 202a-202d include flow elements such as gas supply valves 210a-210d which can be individually configured to supply the control gas to the fuel nozzles at various levels. Although the exemplary embodiment includes four nozzles, any number of nozzles and fuel lines (and valves) can be implemented in alternate embodiments. Compressed air and EGR mixture 203 from the compressed air chamber 124 are circulated through passage 208 into the plurality of fuel nozzles at the back ends of the fuel nozzles. Referring to fuel nozzle 205a for exemplary purposes, the compressed air and EGR mixture 203 are mixed with the fuel 107a and control gas 202a at the fuel nozzle 205a to form a combustible mixture. The combustible mixture is burned at the forward end of fuel nozzle 205a. In an exemplary embodiment of the present disclosure, the amount of control gas at exemplary fuel nozzle 205a can be decreased or increased, thereby increasing or decreasing an oxygen concentration of the combustible mixture at the exemplary fuel nozzle 205a. As shown in FIG. 2, the supply of control gas can be actively controlled via the exemplary supply gas valves 210a-210d. Alternatively, the supply of control gas can be passively controlled via passive flow elements. FIG. 3 shows two exemplary fuel nozzles 205a and 205b having orifices of differing cross-sectional area for receiving the control gas. The orifice 221a for fuel nozzle 205a is smaller than the orifice for fuel nozzle 205b causing the oxygen concentration at fuel nozzle 205a to be greater than the oxygen concentration at fuel nozzle 205b. FIG. 4 shows a conduit for providing the control gas from the control gas supply 220 to the fuel nozzles 205a-205d. The cross-section of each flow divider is selected to provide control gas in a selected proportion to the fuel nozzles 205a-205b. Thus, the flow of control gas can be controlled through a flow element such as an orifice at the nozzle having a selected size, a manifold providing selective distribution of the control gas, a selective flow divider, or other device capable of partitioning the control gas.

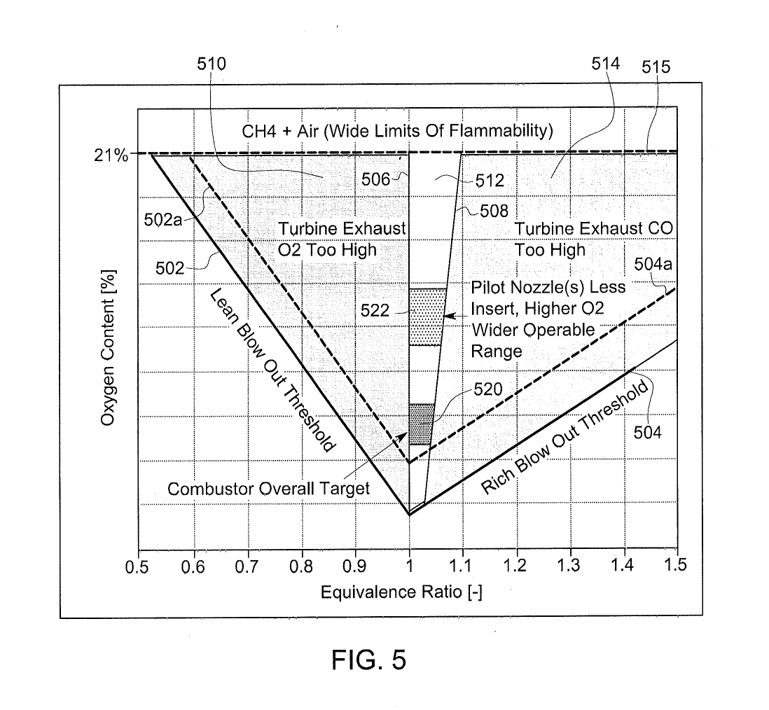

FIG. 5 shows a flame stability diagram showing various regions of flame stability according to an exemplary embodiment of the present disclosure. The x-axis represents a fuel equivalence ratio of a combustible mixture at the flame. Oxygen concentration (percent oxygen) of the combustible mixture is plotted along the y-axis. The fuel equivalence ratio is generally a ratio of the fuel that is supplied to the flame to the amount of fuel consumed by the available oxygen. When the equivalence ratio is 1, then these quantities are equal. When the equivalence ratio is less than 1, then the fuel mixture is considered to be lean. Lean blow out threshold 502 indicates the boundary below which the fuel content of the combustible mixture supplied to the flame is too lean to sustain the flame. The lean operable region, 510, is bounded by equivalence ratio of 1.0 and the lean blow out threshold 502. In the lean operatible region 510, the combustible mixture tends to produces exhaust gas that includes excess oxygen (O₂) when burned. Similarly, an equivalence ratio greater than 1 indicates a fuel-rich mixture. Rich blow out threshold 504 indicates a boundary above which the fuel content of the combustible mixture is too rich to sustain the flame. In the region 514 bounded by CO limit line 508 and rich blow out threshold 504, the combustible mixture tends to produce an exhaust gas that includes high amounts of CO when burned.

As seen in FIG. 5, the lean blow out threshold 502 and rich blow out threshold 504 intersect at some oxygen concentration lower than 21%. Thus, a mixture having less than the oxygen concentration of the intersection does not ignite, regardless of fuel concentration ratio. In various embodiments, the lean blow out threshold 502 and rich blow out threshold 504 intersect at about 13% oxygen concentration. However, this intersection point is not meant as a limitation of the disclosure. Ambient air contains approximately 21% oxygen, which bounds the upper part of the operable range, 515. Therefore, the chemical composition of the combustible mixture at the flame of the gas turbine is within the lean blow out threshold 502, rich blowout threshold 504 and ambient oxygen concentration. To supply a margin of safety, the combustible mixture typically lies within boundaries by 502a, 504a and 515. Operating the gas turbine generator in the region 512 defined by equivalence ratio of 1, 506, upper CO limit 508, ambient O₂ 515 and rich blow out boundary 504a avoids both excess O₂ in the exhaust and in region 510 and high CO in the exhaust in region 514 The separation between the 506 and 508 increases with oxygen content. The generator is typically operated at low oxygen concentrations (region 520) to reduce flame temperature for durability and NOx emissions. In region 520, the flame is stable over a very small range of equivalence ratio, and is close to blow out. At higher oxygen concentrations such as region 522, the available equivalence ratio space is larger, and the flame is farther from the blow out limits. The trade off for operating in region 522 is that the flame temperature is higher. Therefore, a flame burning at a higher oxygen concentration has a wider range of fuel equivalence ratio values over which it can burn in a stable manner.

In one embodiment of the present disclosure, a selected flame at a selected fuel nozzle is operated in region 522 of higher oxygen concentration, while the flames at the other fuel nozzles are operated in region 520 or a region of lower oxygen concentration. The flame operating in region 522 is stable over a wider range of fuel equivalence ratios than a flame operating in region 520. The stability of the selected flame therefore provides stability to the flames at the other fuel nozzles of the combustion chamber 126. Raising the oxygen concentration at the selected fuel nozzle increases an overall emission level at the selected fuel nozzle. Therefore, in order to maintain overall emission levels, the oxygen concentration at the other fuel nozzles is reduced, thereby reducing the emission levels at the other fuel nozzles.

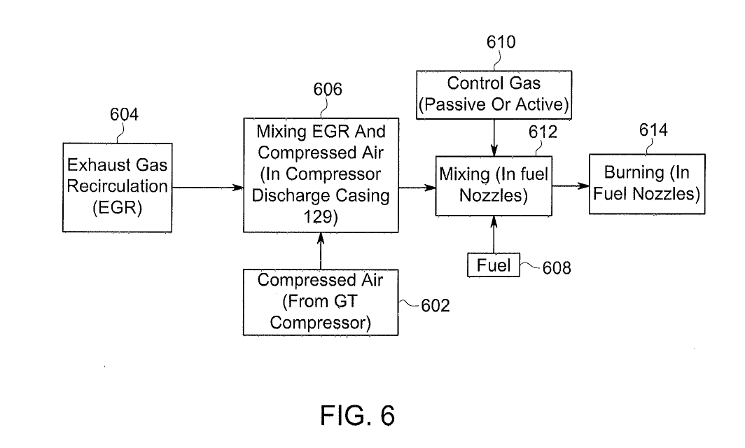

FIG. 6 shows an outline of an exemplary process of selective injection of gases to control a stability of a combustion flame. Compressed air 602 discharged from the compressor section and recirculated exhaust gas (EGR) 604 are mixed in the compressed air chamber 124. The mixture is then directed to the plurality of nozzles 612 of the combustion chamber 126. At the fuel nozzles 612, the compressed air/EGR mixture is further mixed with fuel 608 and a control gas 610 to form a combustible mixture. The control gas can be supplied passively or actively to the fuel nozzles. The combustible mixture is then burned 614 in the combustion chamber 126. The control gas typically includes a composition of at least one of an inert gas and can also include air, nitrogen, and water in various quantities. The composition of the control gas is adjusted to obtain a particular oxygen concentration. In various embodiments, one or more of the EGR 604 and the control gas 610 can be controlled to provide a fuel mixture at a selected nozzle to increase an oxygen content of the combustible mixture. Also, the control gas or EGR can be controlled at the other fuel nozzles to lower oxygen concentration. In one embodiment, the selected fuel nozzle is operated in the region 522 of the flame stability diagram while the other fuel nozzles are operated in the region 520 or in a region of slightly lower oxygen concentration. In an alternate embodiment, more than one of the fuel nozzles is operated in the region 522 and the oxygen concentrations at the other fuel nozzles adjusted accordingly.

Therefore, in one aspect, the present disclosure provides a method of controlling a flame stability at a gas turbine generator, including: forming combustible mixtures at a plurality of fuel nozzles of a combustor of the gas turbine generator; altering an oxygen concentration of at least one of the combustible mixtures at a selected fuel nozzle of the plurality of fuel nozzles; and burning the combustible mixtures at the plurality of fuel nozzles to control the flame stability at the gas turbine generator. In an exemplary embodiment, altering the oxygen concentration further includes increasing the oxygen concentration at the selected fuel nozzle and decreasing the oxygen concentration at the other of the plurality of fuel nozzles. The combustible mixture can include a recirculated exhaust gas and a control gas. Altering the oxygen concentration of the at least one combustible mixture further includes performing at least one of: (i) changing an amount of oxygen supplied to the at least one nozzle; (ii) changing an amount of an inert gas supplied to the at least one nozzle; or (iii) changing an amount of recirculated exhaust gas supplied to the at least one nozzle. The control gas typically includes an inert gas. Altering the oxygen concentration further comprises one of: (i) actively controlling a flow of the control gas; and (ii) passively controlling a flow of the control gas. Altering the oxygen concentration at the selected fuel nozzle can include increasing the oxygen concentration at the selected fuel nozzle to increase a flame stability of a flame at the selected fuel nozzle. In one embodiment, a fuel equivalence ratio of the combustible mixture is adjusted at the selected fuel nozzle to control the flame stability at the selected fuel nozzle.

In another aspect, the present disclosure provides an apparatus for controlling a flame stability of a gas turbine generator, including: a plurality of fuel nozzles of a combustion chamber at the gas turbine generator configured to form a plurality of combustible mixtures; and a flow element configured to alter an oxygen concentration of a combustible mixture at a selected fuel nozzle of the plurality of fuel nozzles to control the flame stability of a flame resulting from burning the combustible mixtures. In one embodiment, the flow element is configured to increase an oxygen concentration at the selected fuel nozzle and to decrease an oxygen concentration at the other of the plurality of fuel nozzles. The combustible mixture includes a recirculated exhaust gas and a control gas. In one embodiment, the flow element is configured to alter the oxygen concentration of the combustible mixture by (i) changing an amount of oxygen supplied to the at least one nozzle; (ii) changing an amount of an inert gas supplied to the at least one nozzle; or (iii) changing an amount of recirculated exhaust gas supplied to the at least one nozzle. The control gas typically includes an inert gas. In various embodiments, the flow element is configured to supply a flow of the control gas to the combustible mixture by one of; (i) active control of the control gas; and (ii) passive control of the control gas. The flow element can be further configured to increase the oxygen concentration of the combustible mixture at the selected fuel nozzle to provide an increased range of flame stability at the selected fuel nozzle. In one embodiment, a control unit is configured to provide a fuel equivalence ratio of the combustible mixture within the increased range of flame stability at the selected nozzle.

In another embodiment, the present disclosure provides a gas turbine generator that includes: a combustor having a plurality of fuel nozzles configured to form combustible mixtures for burning in the combustor; and at least one flow element configured to alter an oxygen concentration of a combustible mixture at at least one of the plurality of fuel nozzles to be different from an oxygen concentration of the combustible mixtures at the other of the plurality of fuel nozzles, wherein the combustor produces substantially a same emission level burning the combustible mixtures having the different oxygen concentrations as when burning combustible mixtures having substantially a same oxygen concentration. In one embodiment, the flow element is configured to increase the oxygen concentration at a selected fuel nozzle of the plurality of fuel nozzles and reduce the oxygen concentration at the other of the plurality of fuel nozzles. The flow element can be configured to alter the oxygen concentration by (i) changing an amount of oxygen supplied to the at least one nozzle; (ii) changing an amount of an inert gas supplied to the at least one nozzle; or (iii) changing an amount of recirculated exhaust gas supplied to the at least one nozzle. In various embodiments, the flow element is configured to alter the injection of the inert gas by one of: (i) active injection of the inert gas; and (ii) passive injection of the inert gas.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of controlling a flame stability at a gas turbine generator, comprising:
forming combustible mixtures at a plurality of fuel nozzles of a combustor of the gas turbine generator;
altering an oxygen concentration of at least one of the combustible mixtures at a selected fuel nozzle of the plurality of fuel nozzles; and
burning the combustible mixtures at the plurality of fuel nozzles to control the flame stability at the gas turbine generator.

2. The method of claim 1, wherein altering the oxygen concentration further comprises increasing the oxygen concentration at the selected fuel nozzle and decreasing the oxygen concentration at the other of the plurality of fuel nozzles.

3. The method of claim 1, wherein the combustible mixture includes a recirculated exhaust gas and a control gas.

4. The method of claim 1, wherein altering the oxygen concentration of the at least one combustible mixture further comprises performing at least one of: (i) changing an amount of oxygen supplied to the at least one nozzle; (ii) changing an amount of an inert gas supplied to the at least one nozzle; and (iii) changing an amount of recirculated exhaust gas supplied to the at least one nozzle.

5. The method of claim 3, wherein the control gas includes an inert gas.

6. The method of claim 3, further comprising altering the oxygen concentration further comprises one of: (i) actively controlling a flow of the control gas; and (ii) passively controlling a flow of the control gas.

7. The method of claim 1, wherein altering the oxygen concentration at the selected fuel nozzle further comprises increasing the oxygen concentration at the selected fuel nozzle to increase a flame stability of a flame at the selected fuel nozzle.

8. The method of claim 7, further comprising adjusting a fuel equivalence ratio of the combustible mixture at the selected fuel nozzle to control the flame stability at the selected fuel nozzle.

9. An apparatus for controlling a flame stability of a gas turbine generator, comprising:
a plurality of fuel nozzles of a combustion chamber at the gas turbine generator configured to form a plurality of combustible mixtures; and
a flow element configured to alter an oxygen concentration of a combustible mixture at a selected fuel nozzle of the plurality of fuel nozzles to control the flame stability of a flame resulting from burning the combustible mixtures.

10. The apparatus of claim 9, wherein the flow element is configured increase an oxygen concentration at the selected fuel nozzle and to decrease an oxygen concentration at the other of the plurality of fuel nozzles.

11. The apparatus of claim 9, wherein the combustible mixture includes a recirculated exhaust gas and a control gas.

12. The apparatus of claim 11, wherein the flow element is further configured to increase the oxygen concentration of the combustible mixture by performing at least one of: (i) changing an amount of oxygen supplied to the at least one nozzle; (ii) changing an amount of an inert gas supplied to the at least one nozzle; and (iii) changing an amount of recirculated exhaust gas supplied to the at least one nozzle

13. The apparatus of claim 11, wherein the control gas includes an inert gas.

14. The apparatus of claim 11, wherein the flow element is further configured to control a flow of the control gas to the combustible mixture by one of: (i) active control of the control gas; and (ii) passive control of the control gas.

15. The apparatus of claim 9, wherein the flow element is further configured to increase the oxygen concentration of the combustible mixture at the selected fuel nozzle to provide an increased range of flame stability at the selected nozzle.

16. The apparatus of claim 15, further comprising a control unit configured to provide a fuel equivalence ratio of the combustible mixture within the increased range of flame stability at the selected nozzle.

17. A gas turbine generator, comprising:
a combustor having a plurality of fuel nozzles configured to form combustible mixtures for burning in the combustor; and
at least one flow element configured to alter an oxygen concentration of a combustible mixture at at least one of the plurality of fuel nozzles to be different from an oxygen concentration of the combustible mixtures at the other of the plurality of fuel nozzles, wherein the combustor produces substantially a same emission level burning the combustible mixtures having the different oxygen concentrations as when burning combustible mixtures having substantially a same oxygen concentration.

18. The gas turbine generator of claim 17, wherein the flow element is configured to increase the oxygen concentration at a selected fuel nozzle of the plurality of fuel nozzles and reduce the oxygen concentration at the other of the plurality of fuel nozzles.

19. The gas turbine generator of claim 17, wherein the flow element is configured to alter the oxygen concentration by performing at least one of: (i) changing an amount of oxygen supplied to the at least one nozzle; and (ii) changing an amount of an inert gas supplied to the at least one nozzle; and (iii) changing an amount of recirculated exhaust gas supplied to the at least one nozzle.

20. The gas turbine generator of claim 19, wherein the flow element is further configured to alter the injection of the inert gas by one of: (i) active injection of the inert gas; and (ii) passive injection of the inert gas.
